(19) United States
(12) Patent Application Publication
(10) Pub. No.: US 2004/0257041 A1
(43) Pub. Date: Dec. 23, 2004

(54) Charging and discharging control apparatus for backup battery

(75) Inventor: Takashi Nagaoka, Ikoma-shi (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Kadoma-shi (JP)

(21) Appl. No.: 10/860,171

(22) Filed: Jun. 3, 2004

(30) Foreign Application Priority Data
Jun. 6, 2003 (JP) 2003-161806

(51) Int. Cl. H02J 7/00

(52) U.S. Cl. 320/128

(57) ABSTRACT

A charging and discharging control apparatus of the present invention includes a combined battery including a plurality of sets of a battery block in which a plurality of secondary batteries are connected in series and a charging switch connected to the battery block, the plurality of sets being connected in parallel. The apparatus also includes a charging control portion for outputting a charging control signal to the charging switch so as to independently charge the battery blocks, and a discharging control portion. The charging control portion outputs a charging completion signal indicating the completion of charging of each of the battery blocks, and the discharging control portion receives a charging completion signal.

### BACKGROUND OF THE INVENTION

1. Field of the Invention

The present invention relates to a combined battery in which battery blocks, each including secondary batteries connected in series, are connected in parallel, and relates to a charging and discharging control apparatus for controlling charging during operation of a commercial power source and discharging during suspension of the commercial power source.

2. Description of the Related Art

Recently, a secondary battery is used widely as a power source backup when a commercial power source is suspended, in electronic equipment such as an information processing apparatus or emergency lighting.

A plurality of the above-mentioned secondary batteries connected in series is referred to as a battery block, and a plurality of battery blocks connected in parallel is referred to as a combined battery. For example, in the case where the discharging power or current value of electronic equipment to be backed up is small, for example, a battery block in which a plurality of cylindrical nickel-hydrogen storage batteries are connected in series is used as a power source backup. On the other hand, for example, in the case where the discharging power or current value of electronic equipment to be backed up is large, generally, a combined battery in which a plurality of battery blocks are connected in parallel is used as a power source backup.

FIG. 9 is a block diagram showing an exemplary configuration of a conventional charging and discharging control apparatus for charging and discharging a combined battery in which a plurality of battery blocks are connected in parallel.

The conventional charging and discharging control apparatus includes a combined battery 10, a charging switch 12, a main power source 4, a charging power source 5, a discharging control portion 13, and a charging control portion 14.

The combined battery 10 uses, for example, a nickel-hydrogen storage battery or the like. The combined battery 10 includes battery blocks 11₁ to 11ₙ (n is an integer of 2 or more) connected in parallel.

The charging power source 5 uses a current obtained from the main power source 4, and charges the combined battery 10 with a constant current. As described above, in the combined battery 10, the battery blocks 11₁ to 11ₙ are connected in parallel to each other, so that a charging current is supplied separately to the battery blocks 11₁ to 11ₙ.

When the charging control portion 14 detects that the combined battery 10 is fully charged, based on voltage information and temperature information of the combined battery 10, the charging control portion 14 outputs a charging suspension signal to the charging switch 12. When the charging switch 12 receives the charging suspension signal, it is turned off. As a result, the charging of the combined battery 10 is suspended (JP7(1995)-203634A).

However, according to the above-mentioned conventional configuration, the combined battery 10 includes the battery blocks 11₁ to 11ₙ connected in parallel, so that a charging current is divided and supplied to each battery block. Thus, in order to fully charge all the battery blocks 11₁ to 11ₙ, it takes a period of time obtained by multiplying a time for fully charging one battery block by the number of battery blocks connected in parallel. Furthermore, according to the above-mentioned conventional configuration, the dischargeable capacity (remaining capacity) of a combined battery cannot be known exactly until all the battery blocks 11₁ to 11ₙ of the combined battery 10 are fully charged. More specifically, in the conventional charging and discharging control apparatus, during a period from a time when the combined battery 10 starts being charged to a time when the charging of all the battery blocks 11₁ to 11ₙ in the combined battery 10 is completed, the charging control portion 13 cannot control discharging exactly in accordance with the remaining capacity of the combined battery 10.

### SUMMARY OF THE INVENTION

Therefore, with the foregoing in mind, it is an object of the present invention to provide an inexpensive charging and discharging control apparatus capable of outputting a charging completion signal on the battery block basis, and efficiently controlling the charging and discharging of the combined battery by grasping the charged state on the battery block basis.

In order to achieve the above-mentioned object, a charging and discharging control apparatus of the present invention includes a combined battery including a plurality of sets of a battery block in which a plurality of secondary batteries are connected in series and a charging switch connected to the battery block, the plurality of sets being connected in parallel. The apparatus also includes a charging control portion for outputting a charging control signal to the charging switch so as to independently charge only one battery block among the plurality of battery blocks, and a discharging control portion. The charging control portion outputs a charging completion signal indicating a completion of charging of each of the battery blocks to the discharging control portion.

Therefore, in the charging and discharging control apparatus of the present invention, the charging control portion outputs charging control signals to charging switches provided on the battery block basis, and controls the charging of each battery block. Since the battery blocks are charged independently, the discharging control portion can receive a charging completion signal output from the charging control portion on the battery block basis. According to this configuration, the discharging control portion can grasp the number of battery blocks whose charging is completed among a plurality of battery blocks, so that the discharging control portion can control the discharging efficiently in accordance with the number of battery blocks.

Preferably, the charging and discharging control apparatus of the present invention further includes a state detection portion for detecting state information on a state of the battery block, wherein the charging control portion determines that charging of the battery block is completed based on the state information detected by the state detection portion.

Preferably, the state information includes a voltage value of the battery block, and the above-mentioned apparatus includes: an elapsed time measurement portion for measuring an elapsed time from a commencement of charging of the battery block; a voltage calculation portion for calculating a change in voltage of the battery block in the elapsed time measured by the elapsed time measurement portion, based on the voltage value of the battery block detected by the state detection portion; and a first comparison portion for comparing the change in voltage of the battery block with a previously set threshold value, wherein the battery block is determined to be fully charged based on a comparison result by the first comparison portion. According to the above configuration, the change in voltage of the battery block per unit time during charging can be obtained, and it can be determined whether or not the battery block is fully charged. The method for determining full charging of a battery block used herein is a so-called −ΔV detection method.

Preferably, the state information includes a temperature of the battery block, and the above-mentioned apparatus includes: an elapsed time measurement portion for measuring an elapsed time from a commencement of charging of the battery block; a temperature calculation portion for calculating a change in temperature of the battery block in the elapsed time measured by the elapsed time measurement portion, based on a temperature of the battery block detected by the state detection portion; and a second comparison portion for comparing the change in temperature of the battery block with a previously set threshold value, wherein the battery block is determined to be fully charged based on a comparison result by the second comparison portion. According to the above configuration, a temperature of the battery block per unit time during charging can be obtained, and it can be determined whether or not the battery block is fully charged. The method for determining full charging of a battery block used herein is a so-called dT/dt detection method.

Preferably, the state information includes a voltage value and a temperature of the battery block, and the above-mentioned apparatus includes: an elapsed time measurement portion for measuring an elapsed time from a commencement of charging of the battery block; a voltage calculation portion for calculating a change in voltage of the battery block in the elapsed time measured by the elapsed time measurement portion, based on the voltage value of the battery block detected by the state detection portion; a temperature calculation portion for calculating a change in temperature of the battery block in the elapsed time measured by the elapsed time measurement portion, based on a temperature of the battery block detected by the state detection portion; a first comparison portion for comparing the change in voltage of the battery block with a previously set threshold value; and a second comparison portion for comparing the change in temperature of the battery block with a previously set threshold value, wherein a completion of charging of the battery block is determined when both a comparison result by the first comparison portion and a comparison result by the second comparison portion determine full charging of the battery block. According to this configuration, the full charging of the battery block can be determined more exactly.

Preferably, the above-mentioned charging and discharging control apparatus further includes a storing portion for storing the number of battery blocks to be charged among the plurality of battery blocks as a number required to be charged, and the charging control portion obtains the number required to be charged from the storing portion, and charges the battery blocks corresponding to the number of the battery blocks indicated by the number required to be charged. According to this configuration, the battery blocks to be stored in a storing portion only need to be charged, whereby charging and discharging control can be performed efficiently.

Preferably, in the charging and discharging control apparatus of the present invention, the storing portion is a non-volatile memory. According to this configuration, even in the case where data of a microcomputer is reset, information such as the number of battery blocks to be charged and the like can be stored.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram showing a configuration of a charging and discharging control apparatus according to Embodiment 1 of the present invention.

FIG. 2 is a block diagram showing a configuration of a charging control portion of the charging and discharging control apparatus according to Embodiment 1 of the present invention.

FIG. 3 is a diagram illustrating a charging control signal according to Embodiment 1 of the present invention.

FIG. 4 is a block diagram showing another aspect of the configuration of the charging control portion of the charging and discharging control apparatus according to Embodiment 1 of the present invention.

FIG. 5 is a block diagram showing another aspect of the configuration of the charging and discharging control apparatus according to Embodiment 1 of the present invention.

FIG. 6 is a block diagram showing still another aspect of the configuration of the charging control portion of the charging and discharging control apparatus according to Embodiment 1 of the present invention.

FIG. 7 is a block diagram showing a configuration of a charging and discharging control apparatus according to Embodiment 2 of the present invention.

FIG. 8A is a diagram illustrating an exemplary charging control signal during operation of a commercial power source according to Embodiment 2 of the present invention. FIG. 8B is a diagram illustrating an exemplary charging control signal during suspension of a commercial power source according to Embodiment 2 of the present invention.

FIG. 9 is a block diagram showing an exemplary configuration of a conventional charging and discharging control apparatus.

### DESCRIPTION OF THE PREFERRED EMBODIMENTS

### Embodiment 1

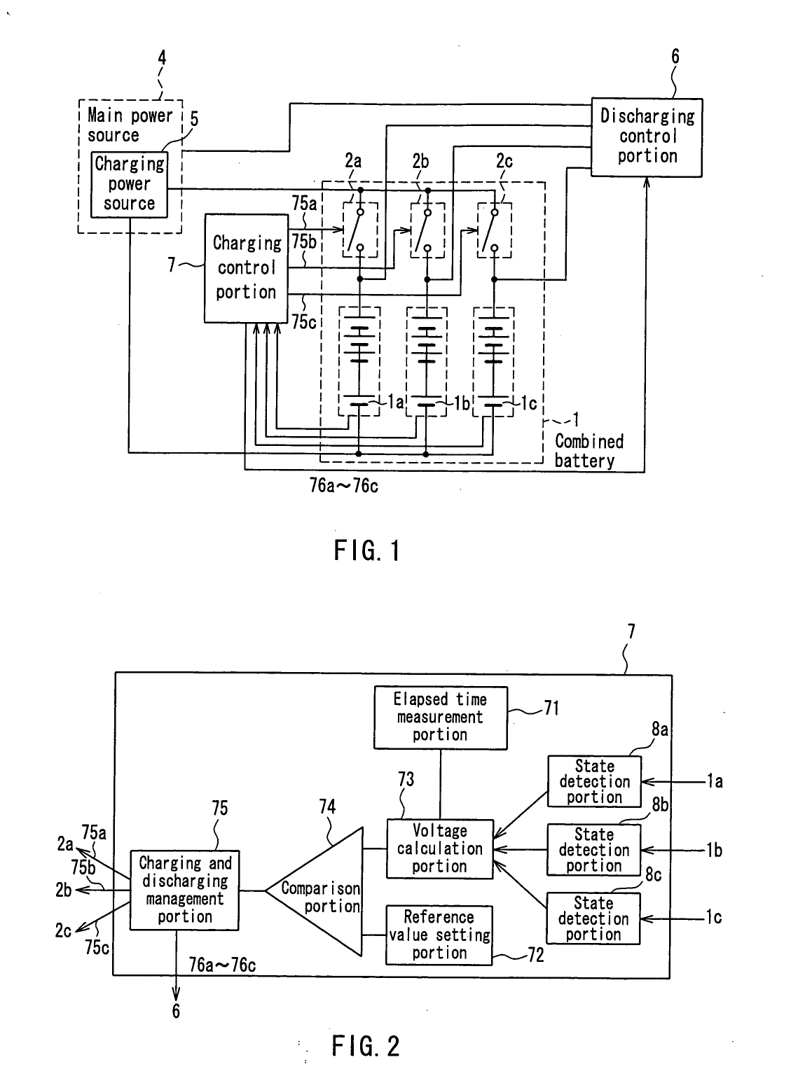

A charging and discharging control apparatus according Embodiment 1 of the present invention will be described with reference to FIG. 1. FIG. 1 is a block diagram showing a configuration of the charging and discharging control apparatus according to Embodiment 1. During operation of a commercial power source, the charging and discharging control apparatus supplies power to electronic equipment or the like (not shown) to be connected. During suspension of the commercial power source, the charging and discharging control apparatus discharges a combined battery and supplies power to the electronic equipment or the like.

As shown in FIG. 1, the charging and discharging control apparatus includes a combined battery 1, a main power source 4, a charging power source 5, a discharging control portion 6, and a charging control portion 7.

The combined battery 1 includes battery blocks 1a, 1b, and 1c connected in parallel. Each of the battery blocks 1a to 1c includes a plurality of secondary batteries connected in series. As the secondary battery, for example, a nickel-hydrogen storage battery or the like can be used. The secondary battery according to the present invention is not limited to this example, and may be, for example, a lead storage battery, a lithium ion battery, or the like.

Furthermore, the combined battery 1 includes charging switches 2a, 2b, and 2c. The charging switches 2a, 2b, and 2c are used for passing a charging current to the battery blocks 1a, 1b, and 1c, or interrupting it. The number of the charging switches 2a to 2c is the same as that of the battery blocks 1a to 1c. The charging switch 2a is connected in series to the battery block 1a, the charging switch 2b is connected in series to the battery block 1b, and the charging switch 2c is connected in series to the battery block 1c.

The main power source 4 receives power from a commercial power source. The main power source 4 supplies power to the discharging control portion 6, and consequently, supplies power to electronic equipment or the like. The charging power source 5 uses current of the main power source 4 as a charging current to charge the combined battery 1.

The discharging control portion 6 is connected to electronic equipment or the like, and sends charging amount information (not shown) to the electronic equipment when the commercial power source is suspended. The charging amount information represents the charging amount of the combined battery 1. The electronic equipment can grasp the charging amount by receiving the charging amount information, thereby selecting data to be backed up.

The charging control portion 7 is composed of, for example, a microcomputer or the like. The charging control portion 7 outputs charging control signals 75a to 75c to turn on/off the charging switches 2a to 2c, in order to control the charging of the battery blocks 1a to 1c. Furthermore, the charging control portion 7 outputs charging completion signals 76a to 76c to the discharging control portion 6, when the charging of the battery blocks 1a to 1c is completed.

Next, the charging control portion 7 of the charging and discharging control apparatus will be described in more detail with reference to FIG. 2.

FIG. 2 is a block diagram showing an internal configuration of the charging control portion 7 of Embodiment 1. As shown in FIG. 2, the charging control portion 7 includes state detection portions 8a to 8c, an elapsed time measurement portion 71, a reference value setting portion 72, a voltage calculation portion 73, a comparison portion 74, and a charging and discharging management portion 75.

The state detection portions 8a to 8c detect voltage values and the like of the battery blocks 1a to 1c, and give them to the charging and discharging management portion 75. Therefore, the number of the state detection portions 8a to 8c is the same as that of the battery blocks 1a to 1c. The state detection portion 8a detects the state of the battery block 1a, the state detection portion 8b detects the state of the battery block 1b, and the state detection portion 8c detects the state of the battery block 1c.

The elapsed time measurement portion 71 is composed of a timer apparatus and the like, and measures an elapsed time from the commencement of charging of the battery blocks 1a to 1c. The voltage calculation portion 73 uses a voltage value before the elapse of a unit time and a voltage value after the elapse of a unit time, thereby obtaining a change in voltage value per unit time. The unit time herein refers to an arbitrary constant time measured by the elapsed time measurement portion 71.

The reference value setting portion 72 is composed of a memory and the like, and previously stores a threshold value for determining each full charging for the battery blocks 1a to 1c. The comparison portion 74 compares whether or not the change in voltage value per unit time calculated by the voltage calculation portion 73 exceeds a threshold value stored in the reference value setting portion 72.

The charging and discharging management portion 75 obtains the charged states of the battery blocks 1a to 1c from the comparison results of the comparison portion 74, and outputs the charging control signals 75a to 75c to the charging switches 2a to 2c, thereby controlling the charging of the battery blocks 1a to 1c. Furthermore, the charging and discharging management portion 75 outputs the charging completion signals 76a to 76c to the discharging control portion 6, when determining that the battery blocks 1a to 1c are fully charged. The charging completion signal 76a shows that the battery block 1a is fully charged. The charging completion signal 76b shows that the battery block 1b is fully charged. The charging completion signal 76c shows that the battery block 1c is fully charged.

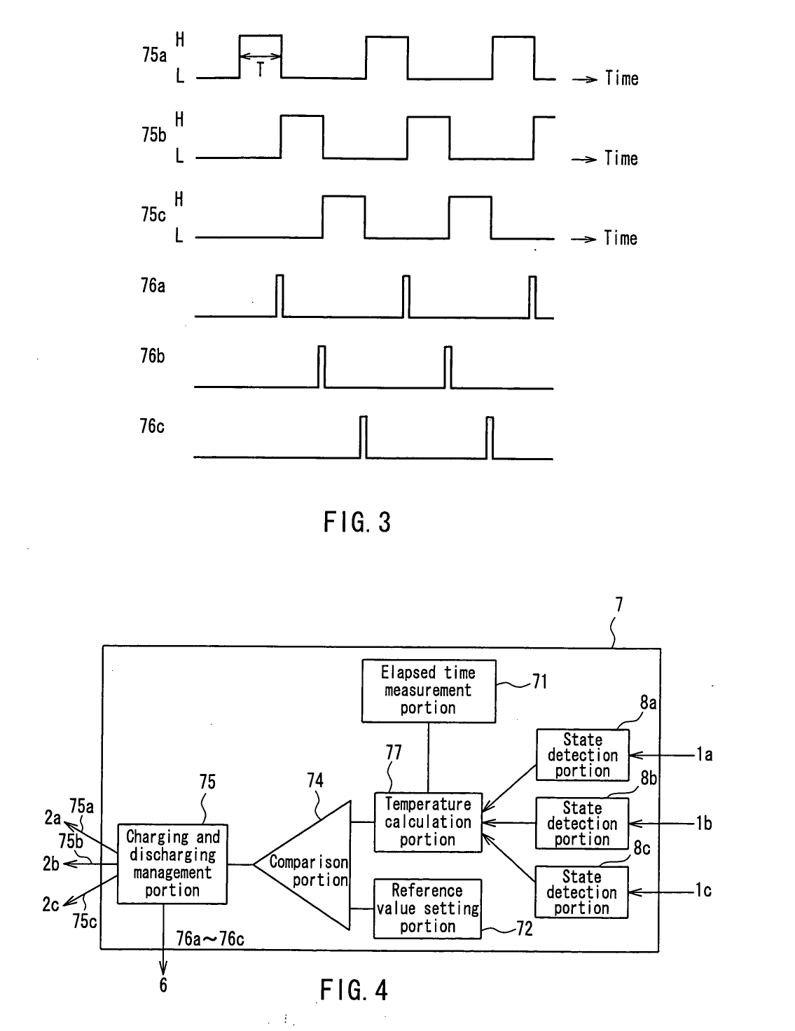

Herein, the charging control signals 75a to 75c for controlling charging commencement and charging completion with respect to the battery blocks 1a to 1c will be described with reference to FIG. 3. FIG. 3 is a diagram showing an exemplary charging control signal. The charging control signals 75a, 75b, and 75c are output to the charging switches 2a, 2b, and 2c. In FIG. 3, the charging switches 2a to 2c are turned on, the charging control signal for starting charging is denoted with “H”, the charging switches 2a to 2c are turned off, and the charging control signal for suspending charging is denoted with “L”. However, the charging control signal according to Embodiment 1 is not limited to this example.

In Embodiment 1, after one battery block in the combined battery 1 is charged, and the charging of the battery block is completed, a subsequent battery block is charged. As an example, the charging control signals 75a to 75c output from the charging and discharging management portion 75, in the case where the battery blocks 1a to 1c are charged successively in the order from the battery block 1a, will be described.

First, by setting only the charging control signal 75a to be “H”, the charging of the battery block 1a is started. Thereafter, the voltage calculation portion 73 calculates a change in voltage value per unit time measured by the elapsed time measurement portion 71, using the voltage value of the battery block 1a detected by the state detection portion 8a. For example, the voltage calculation portion 73 obtains a change in voltage value by taking a difference in voltage value per unit time. A method for obtaining a change in voltage value per unit time is not limited to this example.

For determining if the battery blocks 1a to 1c are fully charged, a −ΔV detection method is used. The −ΔV detection method refers to a full charging detection method using the characteristics in which the voltage value of a battery block reaches a limit value due to the heat generation involved in an oxygen gas absorption reaction at a negative electrode in a charging final stage, and thereafter, the voltage value starts decreasing.

More specifically, by detecting a point where a change in voltage value per unit time of battery blocks 1a to 1c exceeds the threshold value stored in the reference value setting portion 72 and starts decreasing, the battery block is determined to be fully charged. For example, a value such as 5 mV/cell or the like is used as a threshold value for determining full charging. As an example, in the case where the battery block includes three secondary batteries (three cells) connected in series, a threshold value is 15 mV.

The charging and discharging management portion 75 controls the charging control signal 75a to be “H” while the battery block 1a is determined not to be fully charged from the comparison results of the comparison portion 74. During this time, the charging switch 2a is controlled to be an ON state by the charging control signal 75a, so that the battery block 1a is charged. Furthermore, the charging and discharging management portion 75 controls the charging control signals 75b and 75c to be “L”. Because of this, the charging switches 2b and 2c are turned off, so that the battery blocks 1b and 1c are not charged. Thus, only the charging switch 2a is in an ON state, and the charging switches 2b and 2c are in an OFF state, and only the battery block 1a is charged.

When the calculation result by the voltage calculation portion 73 exceeds the threshold value in the reference value setting portion 72 as a result that the battery block 1a continues to be charged, the comparison portion 74 determines that the battery block 1a is fully charged. Herein, the charging and discharging management portion 75 changes the charging control signal 75a from “H” to “L”. The charging switch 2a is turned off, and the charging of the battery block 1a is suspended. Furthermore, the charging and discharging management portion 75 outputs the charging completion signal 76a to the discharging control portion 6 since the charging of the battery block 1a is completed.

Next, the charging and discharging management portion 75 controls the charging and discharging control signal 75b to be “H” in order to turn on the charging switch 2b of the battery block 1b. Thus, only the charging switch 2b is in an ON state, and the charging switches 2a and 2c are in an OFF state, and only the battery block 1b is charged.

Thus, the charging and discharging management portion 75 charges a subsequent battery block after one battery block among the battery blocks 1a to 1c connected in parallel is completed. Therefore, the charging and discharging management portion 75 does not charge two or more battery blocks simultaneously.

As described above, according to the charging and discharging control apparatus according to Embodiment 1, when each of the battery blocks 1a to 1c is fully charged, the charging completion signals 76a to 76c are output to the discharging control portion 6. The discharging control portion 6 receives the charging completion signals 76a to 76c, thereby individually determining whether or not the charging of the battery blocks 1a to 1c is completed. Because of this, the discharging control portion 6 can determine the remaining capacity of the combined battery 1. Therefore, there are the following advantages. For example, when a power failure occurs again during a relatively short period of time after a first power failure, the charging of the combined battery 1 may not be completed at a second power failure. In this case, the discharging control portion 6 can send charging amount information such as “a charging amount is small”, etc., to electronic equipment. When the electronic equipment receives the charging amount information, for example, it can evacuate data preferentially in a decreasing order of priority, using a small charging amount.

In the charging and discharging control apparatus according to Embodiment 1, it is not necessary to provide a current detection resistor portion, a detection circuit portion, and the like for detecting the remaining capacity. Therefore, a large current detection error caused by the heat generation of a current detection resistor is eliminated, whereby an increase in cost can be prevented.

A method for determining the full charging of the battery blocks 1a to 1c according to Embodiment 1 is not limited to a determination method (−ΔV detection method) based on a voltage. For example, the following method may be used. The state detection portions 8a to 8c detect the temperatures of the battery blocks 1a to 1c, and the charging and discharging management portion 75 determines the full charging of the battery blocks 1a to 1c, using a temperature in place of a voltage.

Herein, the charging and discharging control apparatus in the case of adopting a method for determining the full charging, using the temperatures of the battery blocks 1a to 1c, for determining the full charging, will be described with reference to FIG. 4. FIG. 4 is a block diagram showing an internal configuration of the charging control portion 7. The components for realizing the same functions as those in the charging control portion 7 in FIG. 2 are denoted with the same reference numerals as those in FIG. 2, and the description thereof will be omitted here.

The charging control portion 7 of the charging and discharging control apparatus described herein is the same as that of the charging and discharging control apparatus described with reference to FIG. 2, except that a temperature is used in place of a voltage value for determining the full charging of the battery blocks 1a to 1c. Therefore, the description other than that of the method for determining full charging will be omitted.

The charging control portion 7 includes state detection portions 8a to 8c, an elapsed time measurement portion 71, a reference value storing portion 72, a temperature calculation portion 77, a comparison portion 74, and a charging and discharging management portion 75. More specifically, the charging control portion 7 of the charging and discharging control apparatus described herein has a temperature calculation portion 77 in place of the voltage calculation portion 73.

The temperature calculation portion 77 obtains a change in temperature per unit time, using the temperature before the elapse of a unit time and the temperature after the elapse of a unit time. The unit time herein refers to an arbitrarily predetermined time measured by the elapsed time measurement portion 71. The temperature calculation portion 77 calculates a change in temperature per unit time measured by the elapsed time measurement portion 71, using the temperatures of the battery blocks 1a to 1c detected by the state detection portions 8a to 8c. For example, a change in temperature is obtained by taking the difference in temperature per unit time. The calculation method for obtaining a change in temperature per unit time is not limited to this example.

When the full charging of the battery blocks 1a to 1c is determined based on a temperature, a dT/dt detection method is used. More specifically, by detecting a point where an increase in temperature per unit time of a surface temperature of the battery blocks 1a to 1c exceeds the threshold value stored in the reference value setting portion 72, it is determined that the battery blocks 1a to 1c are fully charged. For example, as a threshold value for determining full charging, a value such as 1° C./1 minute or the like is used.

As described above, the charging and discharging control apparatus according to the present invention can determine the full charging of each battery block even based on the temperature of the battery block.

The charging and discharging control apparatus according to Embodiment 1 may determine the full charging by both a determination method based on a temperature and a determination method based on a voltage. In this case, the charging and discharging control apparatus may determine that the charging of the battery block is completed at a time when the full charging of the battery block is detected by either one of the above-mentioned two methods for determining full charging. This can enhance the reliability of charging control.

Alternatively, the charging and discharging control apparatus may determine that the charging of the battery block is completed in the case where the full charging of the battery block is detected by the above-mentioned two determination methods. Because of this, full charging can be determined more exactly.

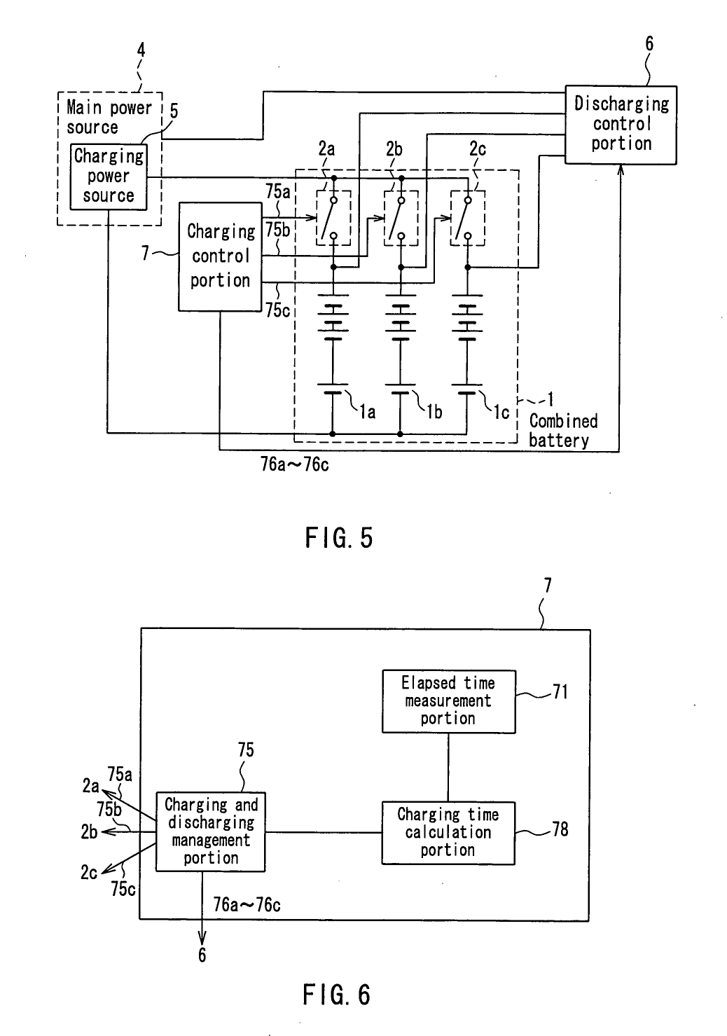

In the case where the discharging amount to electronic equipment is constant, and an accumulated discharging amount can be calculated, the respective charging times of the battery blocks 1a to 1c can be controlled with a timer. Herein, the charging and discharging control apparatus in the case of adopting the timer control will be described with reference to FIG. 5. FIG. 5 is a block diagram showing a configuration of the charging and discharging control apparatus. The charging and discharging control apparatus described herein is the same as that described with reference to FIG. 1 except that the state detection from the battery blocks 1a to 1c is not performed. Thus, even in FIG. 5, the components for realizing the same functions as those in FIG. 1 are denoted with the same reference numerals as those in FIG. 1, and the description thereof will be omitted.

The combined battery 1 is charged with a charging current supplied from the charging power source 5. For this charging, a charging current whose current amount is not varied during charging is used.

FIG. 6 is a block diagram showing an internal configuration of the charging control portion 7 of the charging and discharging control apparatus described with reference to FIG. 5. The charging control portion 7 includes an elapsed time measurement portion 71, a charging time calculation portion 78, and a charging and discharging management portion 75.

The charging time calculation portion 78 calculates a time required for charging the battery blocks 1a to 1c. As described above, the current amount required by electronic equipment connected to the charging and discharging control apparatus can be obtained previously. Furthermore, the charging current for charging the combined battery 1 is not varied (constant current). Therefore, the charging time calculation portion 78 can obtain a charging time (T) capable of fully charging one battery block.

For example, assuming that a current amount required by electronic equipment connected to the charging and discharging control apparatus is Id, the charging current that is not varied is Ic, the discharging time of electronic equipment is td, and the self-discharging amount determined by the environmental temperature of the battery and the discharging time of the battery is Sd, energy E (unit: Ah) consumed by the battery can be obtained by Expression (1), and a charging time T can be obtained by Expression (2). A method for calculating a time required for charging is not limited to this example.

E=Id×td+Sd (1)

T=(Id×td+Sd)/Ic (2)

For example, in the case where the combined battery 1 includes three battery blocks connected in parallel, the energy E consumed by each battery block is (Id×td+Sd)/(Ic×3) from Expression (1). Therefore, the charging time T in the case of charging all the battery blocks is {(Id×td+Sd)/(Ic×3)}×3=(Id×td+Sd)/Ic from Expression (2).

Herein, charging control signals 75a to 75c for controlling the commencement of charging and the completion of charging with respect to the battery blocks 1a to 1c will be described with reference to FIG. 3. FIG. 3 is a diagram illustrating an exemplary charging control signal. “T” shown in FIG. 3 is a charging time.

First, by setting only the charging control signal 75a to be “H”, only the battery block 1a is charged selectively. The elapsed time measurement portion 71 starts measuring a time immediately after the commencement of charging of the battery block 1a, and when the elapsed time from the commencement of charging exceeds a calculation result (charging time T) by the charging time calculation portion 78, it is determined that the battery block 1a is fully charged. Herein, the charging and discharging management portion 75 changes the charging control signal 75a from “H” to “L”. Because of this, the charging switch 2a is turned off, and the charging of the battery block 1a is suspended. Furthermore, the charging and discharging management portion 75 outputs the charging completion signal 76a to the discharging control portion 6 since the charging of the battery block 1a is completed. Then, the charging and discharging management portion 75 changes the charging control signal 75b from “L” to “H”, and starts charging the battery block 1b. The operation thereafter is the same as described above, so that the description thereof will be omitted.

According to the above-mentioned configuration, a time T required for charging a battery block can be calculated previously. Therefore, the charging can be controlled with a timer by the elapsed time measurement portion 71. According to this configuration, compared with the case where the full charging is determined by detecting a change in temperature or voltage, it is not required to set a threshold value to be a reference, which simplifies the configuration.

Furthermore, if the above-mentioned method for determining full charging with a timer is used, and the self-discharging amount of the battery blocks 1a to 1c can be calculated, the present invention also can be used for supplemental charging of the charging amount reduced by self-discharging or the like.

Furthermore, the charging time T also can be calculated based on the capacity of secondary batteries constituting the battery blocks 1a to 1c, a charging current, the self-discharging amount of the secondary batteries, and the like.

In the present embodiment, an example in which the number of battery blocks of the combined battery 1 is three has been described. However, the number of battery blocks that can be used in the present invention is not limited thereto.

### Embodiment 2

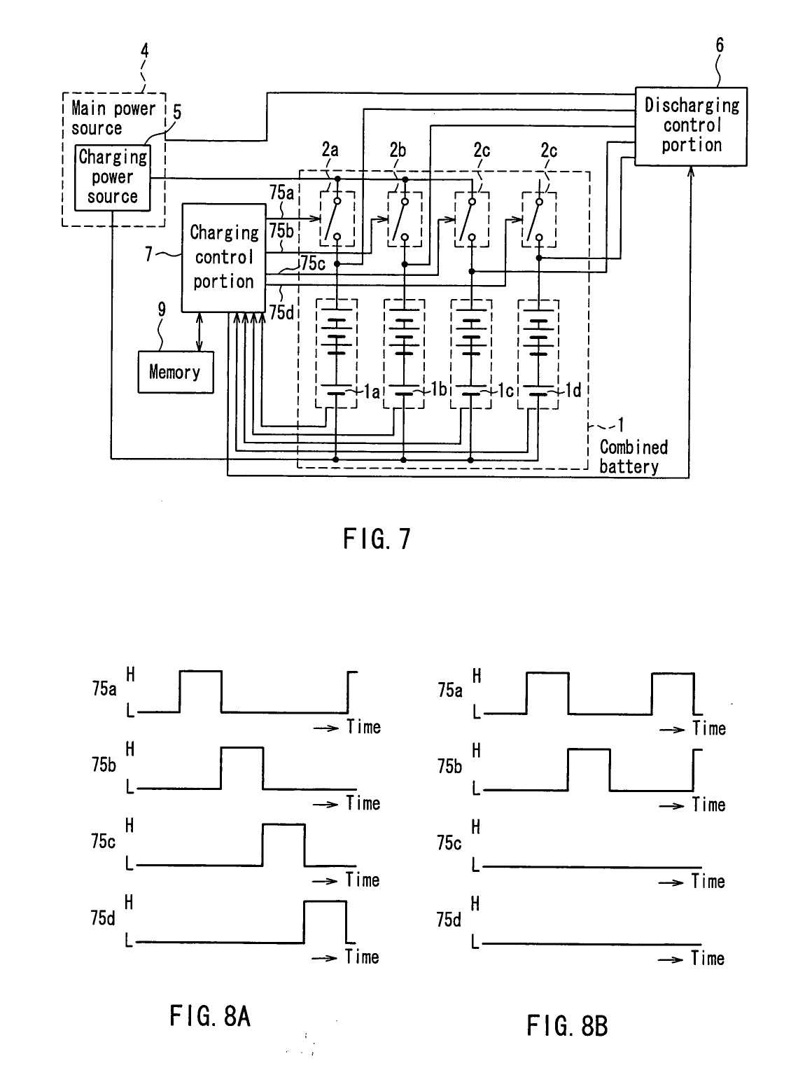

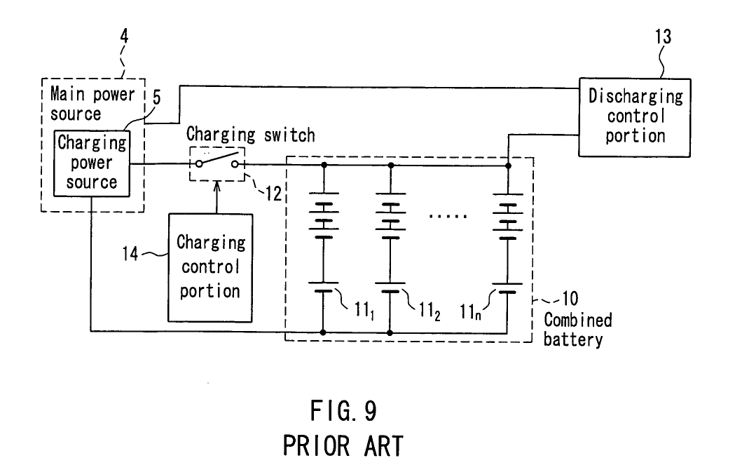

The charging and discharging control apparatus according to Embodiment 2 of the present invention will be described with reference to FIG. 7. The charging and discharging control apparatus according to Embodiment 2 is connected to, for example, electronic equipment such as a server, and supplies power to the electronic equipment during suspension of a commercial power source. In this case, a user determines the number of required battery blocks from the discharging amount of the electronic equipment to be connected, and previously sets the number of battery blocks to be charged in the charging and discharging control apparatus.

FIG. 7 is a block diagram showing a configuration of the charging and discharging control apparatus according to Embodiment 2. In Embodiment 2, the same components as those in the charging and discharging control apparatus of Embodiment 1 are denoted with the same reference numerals as those in Embodiment 1 in FIG. 7, and the description thereof will be omitted.

As shown in FIG. 7, the charging and discharging control apparatus includes a combined battery 1, a discharging control portion 6, a charging control portion 7, and a memory 9. More specifically, the charging and discharging control apparatus of Embodiment 2 is different from that of Embodiment 1 in that a memory 9 is provided.

Herein, it is intended that the combined battery 1 has a configuration in which four (1a to 1d) battery blocks are connected in parallel. The charging control portion 7 is composed of a microcomputer or the like, and includes (four) terminals, corresponding to the number of battery blocks.

The memory 9 is composed of a non-volatile memory or the like. The memory 9 stores the number (M) of battery blocks to be charged in a range not exceeding the number of battery blocks (1a to 1d) of the combined battery 1. For example, in the case where the electronic equipment is a server, the number of battery blocks to be charged is set so that the charging amount capable of backing up minimally required data can be provided. Alternatively, the number of secondary batteries connected in series in a battery block may be used in place of the number of battery blocks. The number of battery blocks to be charged is set in the memory 9 by the user. Herein, the charging control portion 7 charges only the number of battery blocks to be charged, with reference to the memory 9.

Hereinafter, the charging control signals 75a to 75d will be described with reference to FIGS. 8A and 8B. In FIGS. 8A and 8B, the charging switches 2a to 2d are turned on, the charging control signal for starting charging is denoted with “H”, the charging switches 2a to 2d are turned off, and the charging control signal for suspending charging is denoted with “L”. However, the charging control signal according to Embodiment 2 is not limited to this example.

FIG. 8A is a diagram illustrating an exemplary charging control signal in the case of charging all the battery blocks la to id of the combined battery 1 one by one. The charging control portion 7 outputs charging control signals 75a to 75d shown in FIG. 8A, with respect to four battery blocks 1a to 1d of the combined battery 1.

For example, after the charging of the battery blocks 1a to 1c is completed successively, the charging control signal 75d is controlled to be “H”, and the battery block id is charged. When the battery block id is determined to be fully charged, the charging control portion 7 controls the charging control signal 75d to be “L”, and suspends the charging of the battery block 1d. Then, the charging control portion 7 controls the charging control signal 75a to be “H” so as to charge the battery block 1a again.

Herein, as an example, the case where a power failure of a commercial power source occurs continuously at a relatively short time interval will be described. Furthermore, it is assumed that a user previously sets “2” in the memory 9 as the number of battery blocks to be charged after the power failure of a commercial power source. FIG. 8B is a diagram illustrating an example of a charging control signal that charges the battery blocks 1a to 1b, and does not charge the battery blocks 1c to 1d. As shown in FIG. 8B, the charging control portion 7 outputs charging control signals 75a to 75d so as to charge only two battery blocks 1a and 1b among four battery blocks 1a to 1d of the combined battery 1.

First, the charging control portion 7 controls the charging control signal 75a to be “H” in accordance with the number (2) of the battery blocks to be charged, and charges the battery block 1a. During this time, the charging control portion 7 controls the charging control signals 75b to 75d to “L”, and does not charge the battery blocks 1b to 1d.

Next, when determining the full charging of the battery block 1a, the charging control portion 7 controls the charging control signal 75a to be “L”, and completes the charging of the battery block 1a. Furthermore, the charging control portion 7 controls the charging control signal 75b to be “H” and charges the battery block 1b. During this time, the charging control portion 7 controls the charging control signals 75c and 75d to be “L”, and does not charge the battery blocks 1c and 1d.

Upon determining that the battery block 1b is fully charged, the charging control portion 7 controls the charging control signal 75b to be “L”, and completes the charging of the battery block 1b. Herein, since the number of battery blocks to be charged is “2”, the battery block 1a is to be charged next, instead of the battery block 1c. Thereafter, the charging control portion 7 repeats charging the battery blocks 1a and 1b alternately.

As described above, the charging and discharging apparatus according to Embodiment 2 is useful, for example, in the case of keeping a charging amount for evacuating minimum data required for maintaining a system in charging after a power failure of a commercial power source.

Furthermore, the charging and discharging apparatus according to Embodiment 2 allows a user to previously set the number of battery blocks to be charged without changing a microcomputer that is a main component of the charging control portion 7, whereby the number of battery blocks to be charged can be changed. Because of this, the general versatility of the discharging control portion 6 can be enhanced, and the inexpensiveness of the charging and discharging control apparatus can be enhanced, without increasing the number of components.

A non-volatile memory preferably is used. Even in the case where a battery voltage for driving a microcomputer decreases to reset data of the microcomputer, a non-volatile memory can store information such as the number of battery blocks to be charged.

Furthermore, it is preferable that the current amount of electronic equipment to be connected is stored, associated with the number of battery blocks to be charged previously stored in the memory 9. Because of this, the charging control portion 7 can determine the charging amount for keeping a current amount of electronic equipment exactly, whereby charging can be performed more efficiently.

In Embodiment 2, an example, in which the number of battery blocks of the combined battery 1 is four and the number of battery blocks to be charged is two, has been described. However, the number of battery blocks that can be used in the present invention is not limited thereto.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A charging and discharging control apparatus, comprising:
a combined battery including a plurality of sets of a battery block in which a plurality of secondary batteries are connected in series and a charging switch connected to the battery block, the plurality of sets being connected in parallel;
a charging control portion for outputting a charging control signal to the charging switch so as to independently charge only one battery block among the plurality of battery blocks; and
a discharging control portion
wherein the charging control portion outputs a charging completion signal indicating a completion of charging of each of the battery blocks to the discharging control portion.

2. The charging and discharging control apparatus according to claim 1, further comprising a state detection portion for detecting state information on a state of the battery block,
wherein the charging control portion determines that charging of the battery block is completed based on the state information detected by the state detection portion.

3. The charging and discharging control apparatus according to claim 2, wherein the state information includes a voltage value of the battery block,
the apparatus comprises:
an elapsed time measurement portion for measuring an elapsed time from a commencement of charging of the battery block;
a voltage calculation portion for calculating a change in voltage of the battery block in the elapsed time measured by the elapsed time measurement portion, based on the voltage value of the battery block detected by the state detection portion; and
a first comparison portion for comparing the change in voltage of the battery block with a previously set threshold value,
wherein the battery block is determined to be fully charged based on a comparison result by the first comparison portion.

4. The charging and discharging control apparatus according to claim 2, wherein the state information includes a temperature of the battery block,
the apparatus comprises:
an elapsed time measurement portion for measuring an elapsed time from a commencement of charging of the battery block;
a temperature calculation portion for calculating a change in temperature of the battery block in the elapsed time measured by the elapsed time measurement portion, based on a temperature of the battery block detected by the state detection portion; and
a second comparison portion for comparing the change in temperature of the battery block with a previously set threshold value,
wherein the battery block is determined to be fully charged based on a comparison result by the second comparison portion.

5. The charging and discharging control apparatus according to claim 2, wherein the state information includes a voltage value and a temperature of the battery block,
the apparatus comprises:
an elapsed time measurement portion for measuring an elapsed time from a commencement of charging of the battery block;
a voltage calculation portion for calculating a change in voltage of the battery block in the elapsed time measured by the elapsed time measurement portion, based on the voltage value of the battery block detected by the state detection portion;
a temperature calculation portion for calculating a change in temperature of the battery block in the elapsed time measured by the elapsed time measurement portion, based on a temperature of the battery block detected by the state detection portion;
a first comparison portion for comparing the change in voltage of the battery block with a previously set threshold value; and
a second comparison portion for comparing the change in temperature of the battery block with a previously set threshold value,
wherein a completion of charging of the battery block is determined when both a comparison result by the first comparison portion and a comparison result by the second comparison portion determine full charging of the battery block.

6. The charging and discharging control apparatus according to claim 1, further comprising a storing portion for storing the number of battery blocks to be charged among the plurality of battery blocks as a number required to be charged, and
the charging control portion obtains the number required to be charged from the storing portion, and charges the battery blocks corresponding to the number of the battery blocks indicated by the number required to be charged.

7. The charging and discharging control apparatus according to claim 6, wherein the storing portion is a non-volatile memory.
